(19) United States
(12) Patent Application Publication
(10) Pub. No.: US 2011/0017147 A1
(43) Pub. Date: Jan. 27, 2011

(54) Pet grooming station and system

(76) Inventor: Dale Petruzzi, Carmel, IN (US)

Correspondence Address: KRIEG DEVAULT LLP, ONE INDIANA SQUARE, SUITE 2800, INDIANAPOLIS, IN, 46204-2079, US

(21) Appl. No.: 12/460,599

(22) Filed: Jul. 22, 2009

(51) Int. Cl. A01K 13/00; A01K 29/00

(52) U.S. Cl. 119/604; 119/671

(57) ABSTRACT

A pet grooming system is disclosed that is configured to wash and groom pets. The system includes a housing having a base, a first side wall and a second side wall extending upwardly from the base. The first and second side walls are oriented in an opposing relationship with each other. A front and rear opening is defined by respective ends of the first side wall and the second side wall. A front and rear door is movably connected with at least one of the first side wall or the second side wall such that the front and rear doors can be closed thereby at least partially closing off access to the front and rear openings. A plurality of fluid jets is positioned on the base, the first side wall, and the second side wall. A drain is positioned in the base such that fluid can exit the interior space.

### BACKGROUND

The present application relates to grooming pets, and more particularly but not exclusively relates to a pet grooming station and system configured to allow a pet owner to wash and groom their pet.

Presently available pet grooming stations consist of storage shelves and/or drawers, racks for hanging instruments, and mirrors that allow the pet owner to observe their pet while grooming. However, a major part of the grooming process consists of bathing the pet. Currently, most pet owners bath their pets in bathtubs, showers, utility sinks, or using a hose outside. Therefore, developments in the technology are desirable.

### SUMMARY

One embodiment is a unique apparatus and system for grooming a pet. Further embodiments, forms, objects, features, advantages, aspects, and benefits shall become apparent from the following description and drawings.

### BRIEF DESCRIPTION OF THE DRAWINGS

FIG. 1 is a perspective view of a pet grooming system.

FIG. 2 is a top view of the pet grooming system.

FIG. 3 is a representative fluid jet.

FIG. 4 is another representative fluid jet.

FIG. 5 is a component view of the pet grooming system.

FIG. 6 is a control and fluid flow diagram of the pet grooming system.

### DESCRIPTION OF ILLUSTRATIVE EMBODIMENTS

For purposes of promoting an understanding of the principles of the invention, reference will now be made to the embodiments illustrated in the drawings and specific language will be used to describe the same. It will nevertheless be understood that no limitation of the scope of the invention is thereby intended, any alterations and further modifications in the illustrated device, and such further applications of the principles of the invention as illustrated therein being contemplated as would normally occur to one skilled in the art to which the invention relates.

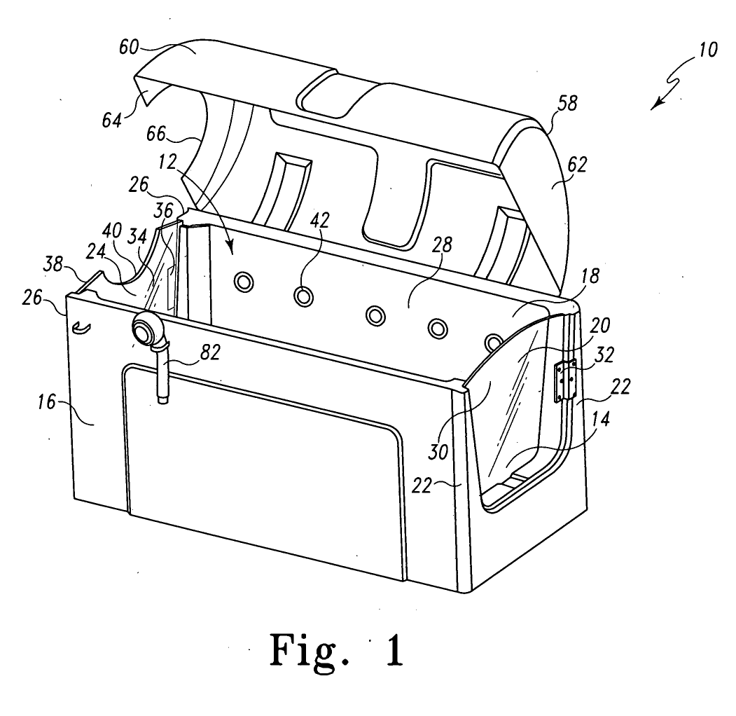

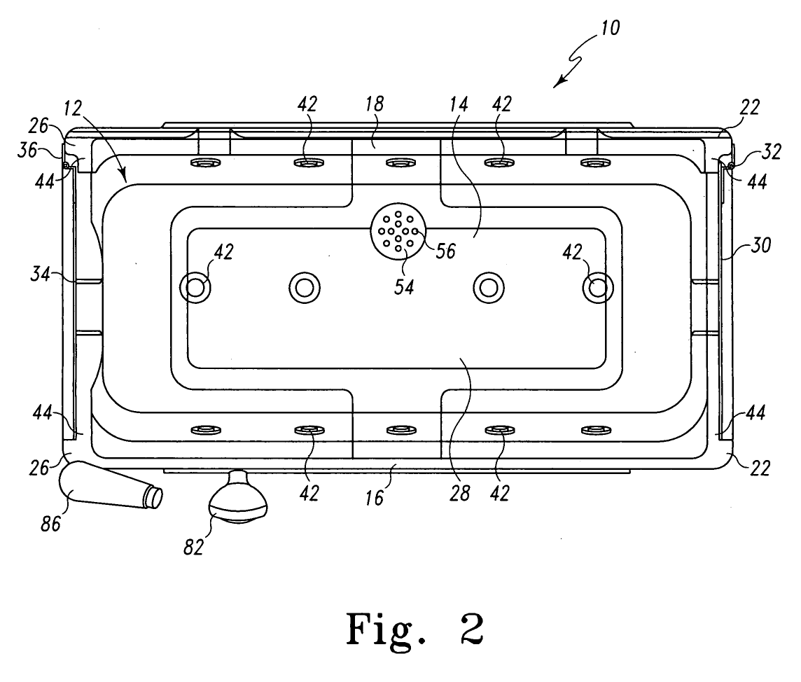

Referring collectively to FIGS. 1 and 2, a pet grooming station and/or system 10 is illustrated that includes a housing 12. The housing 10 includes a base or floor 14, a first or front side wall 16 and a second or rear side wall 18. Side walls 16, 18 extend upwardly from the base 14. In one form, the side walls 16, 18 are integrally molded to the base 14. In another representative form, the side walls 16, 18 can be separate pieces that are connected to the base 14. As illustrated, the side walls 16, 18 are oriented in an opposing relationship to each other. The base 14 can be found such that the upper surface of the base 14 includes a gripping floor so that the pet will not slip.

The housing 12 includes a right side or rear opening 20 that is defined by respective right side ends 22 of the first side wall 16 and second side wall 18. In addition, the housing 12 includes a left side or front opening 24 defined by respective left side ends 26 of the first side wall 16 and second side wall 18. As will be discussed in greater detail below, the rear opening 20 is provided so that a pet can enter an interior space or cavity 28 defined by the base 14, the first side wall 16 and the second side wall 18. In one form, the rear and front openings 20, 24 have a generally U-shaped configuration, but other configurations are envisioned.

As illustrated best in FIG. 1, a rear door 30 is movably connected with at least one of the first side wall 16 or second side wall 18. The rear door 30 is connected with one of the side walls 16, 18 such that the rear door 30 can be moved between an open and closed position. In one form of the present invention, the rear door 30 is connected with one of the side walls 16, 18 with a hinge 32. The hinge 32 is connected with one of the side walls 16, 18 and the rear door 30. In a closed state or position, the rear door 30 partially or completely closes the rear opening 20 thereby securing the pet within the interior space 28 defined by the housing 12.

A front door 34 is also movably connected with at least one of the first side wall 16 or second side wall 18. The front door 34 is connected with one of the side walls 16, 18 such that the front door 34 can be moved between an open and closed position. In one form, the front door 34 is connected with one of the side walls 16, 18 with a second hinge 36. The hinge 36 is connected with one of the side walls 16, 18 and the front door 34. In a closed state, the front door 34 partially or completely closes the front opening 24 thereby securing the pet within the interior space 28 defined by the housing 12. In one representative form, an upper portion 38 of the front door 34 includes a semi-circular shaped cutout 40, which may take the form of other shapes in other forms of the present invention. The cutout 40 allows at least a portion of the head of the pet to be positioned outside of the interior space 28 of the housing 12 during the washing process.

Referring to FIGS. 1 and 2, a plurality of fluid jets 42 are positioned along the base 14, the first side wall 16, and the second side wall 18. The fluid jets 42 are oriented such that fluid is discharged into the interior space 28 defined by the base 14, the first side wall 16, the second side wall 18, the rear door 30 and the front door 34 (i.e.—when doors 30, 34 are closed). When in the closed position, the doors 30, 34 preferentially create a fluid tight seal between the side walls 16, 18 such that fluid does not escape the housing 12. As best illustrated in FIG. 2, a lip 44 on the right side ends 22 and left side ends 26 extends inwardly beyond portions of doors 30, 34 to prevent fluid from escaping the interior space 28 defined by the housing 12.

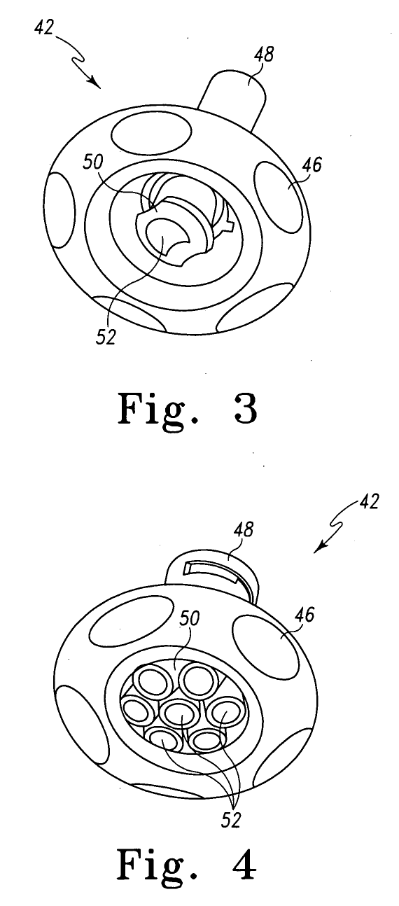

Referring to FIG. 3, in one form the fluid jet 42 includes a jet housing 46, an input port 48, and a nozzle 50. The input port 48 is connected with a fluid supply or source 104 (see FIG. 6) and during operation fluid exits through nozzle 50 as fluid is supplied from the fluid source 104 to the input port 48. In this form, nozzle 50 includes a single output port 52. In addition, the nozzle 50 is configured such that the direction in which fluid exits the nozzle 50 may be adjusted by movement of the nozzle 50. Referring to FIG. 4, in yet another form the nozzle 50 can include a plurality of output ports 52. Utilization of a plurality of output ports 52 provides better fluid coverage in the interior space 28 defined by the housing 12. Although seven output ports 52 are illustrated in this representative form, it should be appreciated that any number of output ports 52 could be utilized in other forms.

Referring back to FIG. 2, a drain 54 is included in the base 14 that is configured to allow fluid to exit the interior space 28. The drain 54 includes a plurality of apertures 56 that allow fluid that is used to wash the pet to exit the system 10. Although not specifically illustrated, the drain 54 can be connected with a hose or tube that allows the user to direct where the fluid travels after exiting the drain 54. For example, the end of the tube may be placed in a bathtub or sink so that the fluid can be drained directly into conventional drains.

Referring back to FIG. 1, the pet grooming system 10 also includes a lid 58 that is connected with one of the side walls 16, 18. In this form, the lid 58 is connected with rear side wall 18. The lid 58 is configured to move or be positioned between an open position in which the interior space 28 is exposed and a closed position in which the interior space 28 is at least partially covered. Pets tend to shake when wet and as such, the lid 58 prevents fluid from exiting the interior space 38. In addition, fluid exiting the fluid jets 42 is also prevented from exiting the interior space 38 through the use of lid 58. As illustrated, the lid 58 includes a semi-circular shaped top portion 60 and a semi-circular shaped right side portion 62 and left-side portion 64. The left-side portion 64 includes a semi-circular shaped cutout 66 that is configured to match up with the cutout 40 of the front door 34. As with the cutout 40 in the front door 34, the cutout 66 in the lid 58 allows the pet's head to safely stick out of or protrude from the pet grooming system 10 while being washed so that the pet feels safe and secure in the pet grooming system 10.

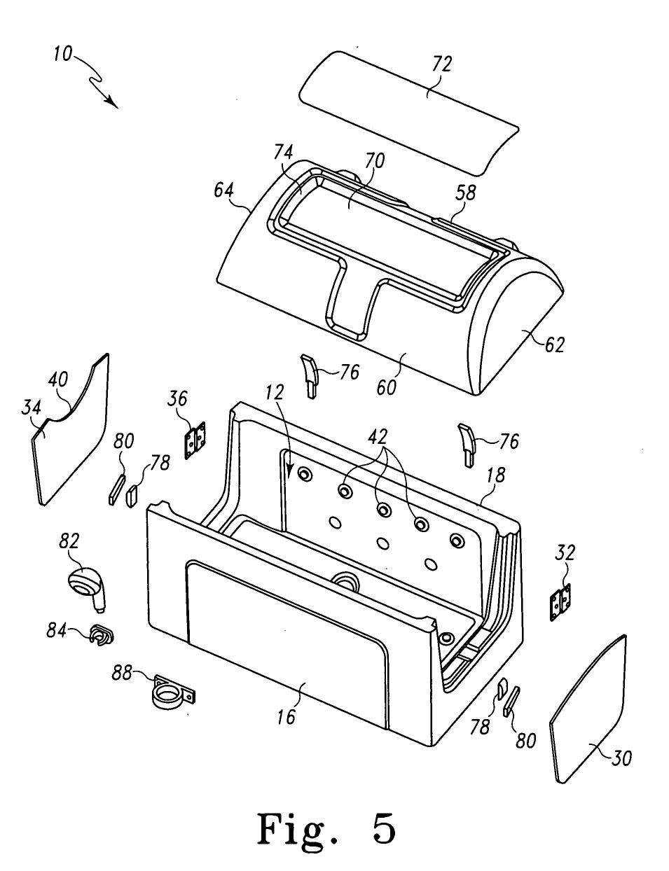

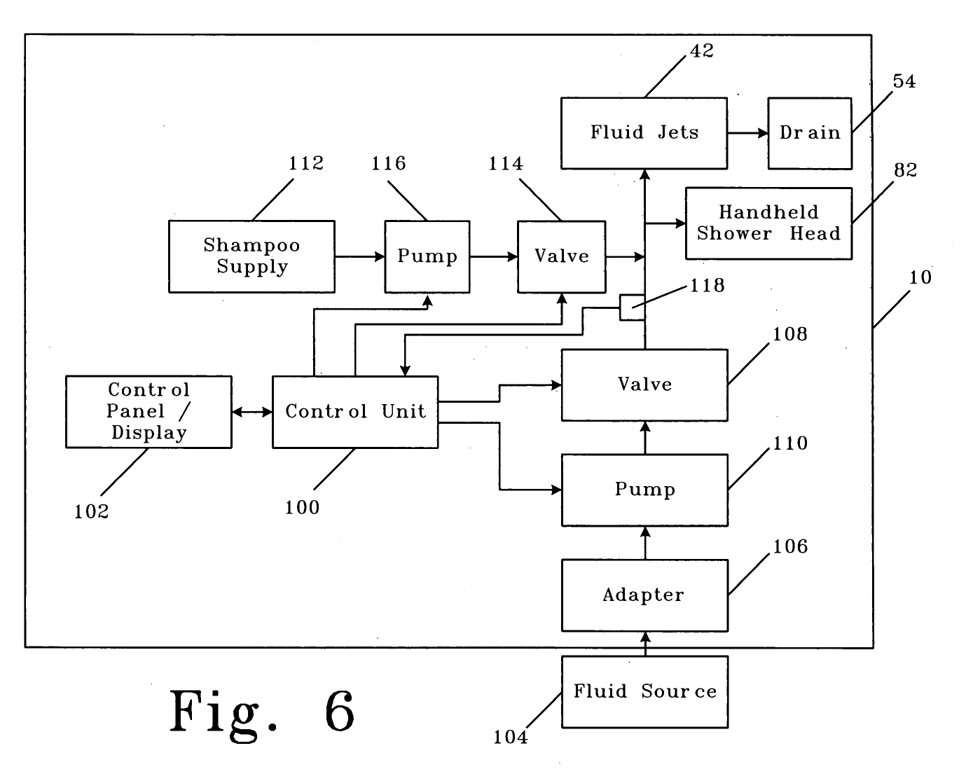

Referring to FIG. 5, a component view of the pet grooming system 10 is depicted that shows various components of the pet grooming system 10 prior to assembly. The lid 58 includes a generally rectangular shaped aperture 70 on an upper portion of the lid 58. A transparent cover 72 is included that fits within a recessed area 74 around the aperture 70. In this form, the transparent cover 72 can be selectively removed from the aperture 70. In other forms, the transparent cover 72 is connected with the lid 58 by one or more hinges, similar to the hinges 32, 36 used to connect the rear and front doors 30, 34 to the side walls 16, 18. The lid 58 is connected with one of the respective side walls 16, 18 by one or more hinges 76.

In one form, a first magnetic strip 78 is connected with the base 14 near the rear door 30. A second magnetic strip 80 is connected with a lower portion of the rear door 30. When the rear door 30 is closed, the respective magnetic strips 78, 80 act to tend to keep the rear door 30 closed so that it will not inadvertently open while the pet is being washed. The same magnetic strips 78, 80 can also be used for the front door 34. As with the rear door 30, the magnetic strips 78, 80 tend to keep the front door 34 closed so that it will not inadvertently open while the pet is being washed.

As further illustrated, in one form the pet grooming system 10 can include a handheld shower head 82. The handheld shower head 82 is a push-button type shower head such that fluid is only expelled from the handheld shower head 82 when the button is depressed. A first clip 84 is included that is used to secure the shower head 82 to one of the respective side walls 16, 18. In yet another form, a hair dryer 86 can be included that is used to dry the hair of the pet after washing is accomplished. A second clip 88 is included that is used to secure the hair dryer 86 to one of the respective side walls 16, 18. As such, clips 84, 88 are connected with one of the respective side walls 16, 18.

Referring to FIG. 6, a fluid and control diagram is illustrated that depicts various aspects of the pet grooming system 10. As illustrated, in one representative form the pet grooming system 10 includes a control unit 100. The control unit 100 can be a microprocessor based control, an analog controller, a digital controller, or any combination thereof. The control unit 100 is used to control various aspects of the pet grooming system 10 as set forth in greater detail below. In one representative form of the present invention, the control unit 100 is connected with a control panel/display 102. The control panel/display 102 can be a single unit or can be broken out separately into a control panel and a display.

The control panel/display 102 is configures for use by a user to control various processes. In one form, the control unit 100 is configured to operate the pet grooming system 12 in one of three modes, which may comprise a soak mode, a shampoo mode, and a rinse mode. In the soak mode, fluid is discharged from the fluid jets 42 to soak the pet before being washed. In the shampoo mode, fluid together with a flow of shampoo is discharged from the fluid jets 42 so that the pet is washed with soap and water. In the rinse mode, fluid is once again discharged from the fluid jets 42 to rinse the soap and water off of the pet. The control panel 102 can include one or more buttons that allow the user to control which mode the pet grooming system 10 operates in.

As illustrated, the pet grooming system 10 is connected with a fluid source 104. The fluid source 104 is used to supply fluid (i.e.—water) to the fluid jets 42. The fluid source 104 can comprise a sink, a bathtub, a faucet, a garden hose, and so forth. The fluid source 104 is connected with the pet grooming system 10 by an adapter 106 that is configured to mate with the particular type of fluid source 104 being used at any given time. In one representative form of the present invention, the control unit 100 is connected with a valve 108 that is used to control when fluid flows to the fluid jets 42 from the fluid source 104. As such, the control unit 100 is configured to activate and deactivate the valve 108 thereby either allowing or disallowing the flow of fluid to the fluid jets 42. In yet another form, the control unit 100 can be connected with a pump 110 that is used to pump fluid to the fluid jets 42. As further illustrated, fluid is also selectively supplied to the handheld shower head 82 through the fluid source 104.

A replaceable shampoo supply 112 is also selectively in fluid communication with the fluid jets 42. The shampoo supply 112 is configured to inject or supply shampoo into the flow of fluid that is dispensed by the fluid jets 42. In one representative form, a valve 114 is used to control when shampoo is allowed to flow into the flow of fluid that is dispensed by the fluid jets 42. The valve 114 may be manually opened by the user of the pet grooming system 10 when it is time to shampoo the pet. In yet another form, the valve 114 can be connected with the control unit 100 which is configured to open the valve 114 when operating in the shampoo mode. In yet another representative form of the present invention, a pump 116 can be included to aid in supplying the shampoo from the shampoo supply 112 to the flow of fluid from the fluid source 104. The pump 116 is connected with the control unit 100 which controls operation of the pump 116.

In yet another form of the present invention, a temperature sensor 118 can be placed in fluid communication with the flow of fluid supplied by the fluid source 104. The temperature sensor 118 is used to monitor the temperature of the fluid being supplied by the fluid source 104. The temperature sensor 118 is connected with the control unit 100 which continuously monitors the temperature of the fluid. If the temperature of the fluid reaches an upper threshold value, the control unit 100 is configured to issue a warning on the display 102 and/or automatically close valve 108 thereby shutting off the flow of fluid to the fluid jets 42. This ensures that the pet is not exposed to fluid temperatures that may injure the pet.

While the invention has been described in connection with what is presently considered to be the most practical and preferred embodiment, it is to be understood that the invention is not to be limited to the disclosed embodiment(s), but on the contrary, is intended to cover various modifications and equivalent arrangements included within the spirit and scope of the appended claims, which scope is to be accorded the broadest interpretation so as to encompass all such modifications and equivalent structures as permitted under the law. In reading the claims it is intended that when words such as “a,” “an,” “at least one” and “at least a portion” are used, there is no intention to limit the claim to only one item unless specifically stated to the contrary in the claim. Further, when the language “at least a portion” and/or “a portion” is used the item may include a portion and/or the entire item unless specifically stated to the contrary.

What is claimed is:

1. A system, comprising:
a housing having a base and a first side wall and a second side wall extending upwardly from the base, where said first and second side walls are oriented in an opposing relationship with one another;
a rear opening defined by respective right side ends of said first side wall and second side wall;
a front opening defined by respective left side ends of said first side wall and second side wall;
a rear door movably connected with at least one of said first side wall or said second side wall such that said rear door can be closed thereby at least partially closing off access to said rear opening;
a front door movably connected with at least one of said first side wall or said second side wall such that said front door can be closed thereby at least partially closing off access to said front opening;
a plurality of fluid jets positioned in said base, said first side wall, and said second side wall, where said fluid jets are oriented such that fluid is discharged from said fluid jets into an interior space defined by said base, said first side wall, said second side wall, said rear door and said side door; and
a drain positioned in said base such that fluid can exit said interior space.

2. The system of claim 1, further comprising a lid movably connected with an upper portion of at least one of said first side wall or said second side wall configured to at least partially cover an upper opening defined by said first and second side walls.

3. The system of claim 2, further comprising an opening in said lid.

4. The system of claim 3, further comprising at least a partially transparent cover movably connected with said lid configured to move between an open and closed position in relation to said opening.

5. The system of claim 1, where said plurality of jets include an adjustable nozzle configured to project fluid in a user defined direction in said interior space.

6. The system of claim 5, where said nozzle includes a plurality of output ports.

7. The system of claim 1, further comprising a control unit configured to control fluid flow through said plurality of jets.

8. The system of claim 7, where said control unit is configured to control fluid flow to flow in a soak mode, a shampoo mode, and a rinse mode.

9. The system of claim 8, further comprising a fluid supply connected with said plurality of jets configured to supply fluid to said plurality of jets.

10. The system of claim 1, further comprising a shampoo supply configured to supply shampoo to fluid flow to said plurality of fluid jets.

11. The system of claim 9, further comprising a valve connected with said shampoo supply configured to control the supply of said shampoo to fluid flow to said plurality of fluid jets.

12. The system of claim 1, further comprising a handheld shower head connected configured to selectively provide a flow of fluid for grooming a pet.

13. A system, comprising:
a housing comprising a base, a rear side wall, and a front side wall, where said base, said rear side wall, and said front side wall define an interior space;
a first set of fluid jets positioned in said base, a second set of fluid jets positioned in said rear side wall, and a third set of fluid jets positioned in said front side wall, where said first, second, and third set of fluid jets are configured to direct a flow of fluid into said interior space;
a rear door movably positioned in a first opening defined by said base, said rear side wall and said front side wall and front door movably positioned in a second opening defined by said base, said rear side wall and said front side wall, where an upper portion of said front door includes a first cutout;
a lid movably connected with at least one of the rear side wall or the front side wall, where a respective side of said lid includes a second cutout;
a shampoo supply connected with said flow of fluid configured to selectively supply shampoo to said flow of fluid; and
a drain located in said base.

14. The system of claim 13, where said rear door and said front door are connected to at least one of said rear side wall or said front side wall by a hinge.

15. The system of claim 13, further comprising a controller configured to control said flow of fluid and said supply of shampoo.

16. The system of claim 15, where said controller is configured to control the supply of shampoo from said shampoo supply.

17. The system of claim 13, further comprising a handheld shower head configured to selectively supply fluid from said flow of fluid.

18. The system of claim 13, further comprising means for monitoring a temperature value of said flow of fluid.

19. The system of claim 13, further comprising an adapter configured to be connected to a fluid source.

20. The system of claim 13, further comprising a control panel configured to control the supply of shampoo to said flow of fluid.
